(19) United States
(12) Patent Application Publication
(10) Pub. No.: US 2009/0065499 A1
(43) Pub. Date: Mar. 12, 2009

(54) INDUCTION COOKWARE

(75) Inventor: Raymond O. England, Harrisville, RI (US)

Correspondence Address: Bose Corporation;c/o Donna Griffiths, The Mountain, MS 40, IP Legal - Patent Support, Framingham, MA, 01701, US

(73) Assignee: BOSE CORPORATION, Framingham, MA (US)

(21) Appl. No.: 12/031,226

(22) Filed: Feb. 14, 2008

Related U.S. Application Data
(60) Provisional application No. 60/970,795, filed on Sep. 7, 2007.
(60) Provisional application No. 60/970,766, filed on Sep. 7, 2007.
(60) Provisional application No. 60/970,775, filed on Sep. 7, 2007.
(60) Provisional application No. 60/970,785, filed on Sep. 7, 2007.

(51) Int. Cl. H05B 6/12

(52) U.S. Cl. 219/621

(57) ABSTRACT

An induction cooking utensil is constructed such that it cooks food within its chamber while maintaining a relatively cool outer surface (e.g., preferably an outer surface that is cool enough to pick up with one's bare hands). The cooking utensil includes an inner wall that is made at least in part of an electrically conductive material and an outer wall that is made at least in part of the electrically non-conductive material and separated from the inner wall by a gap. Holes are formed in the outer wall that permit circulation of air between the gap and the outside of the cooking utensil to provide for convective cooling.

### CROSS-REFERENCE TO RELATED APPLICATIONS

This application claims benefit from U.S. Provisional Patent Application No. 60/970,795 filed Sep. 7, 2007, 60/970,766 filed Sep. 7, 2007, 60/970,775 filed Sep. 7, 2007, and 60/970,785 filed Sep. 7, 2007, the contents of each of which are incorporated herein by reference.

### TECHNICAL FIELD

This disclosure relates to cookware for induction cooktops.

### BACKGROUND

Some conventional cooktops deliver heat to a cooking utensil (e.g., a pan, pot, skillet, etc.) by for example a gas flame or electric resistance coil. In these cooktops, any material that lies between the heat source and the cooking utensil (e.g., a glass cooktop) is also heated. Induction cooktops work differently. In an induction cooktop, an alternating current in an induction coil produces a time dependent magnetic field that induces eddy currents in electrically conductive materials near the coil, such as a ferromagnetic component (or the target material) of induction cooking utensils. As eddy currents flow within the target material, it becomes hot via a joule heating mechanism. Heat in the target is conducted through the body of the cooking utensil to the food surface, and the food is cooked. Unlike gas or electric cooktops, induction cooktops will not directly heat non-conductive materials (such as a glass cooktop) that are placed between the induction coil and the target material. However, any such non-conductive materials placed between the induction coil and the target material may be indirectly heated by the radiant, convective, or conductive heat emanating from the hot target material.

### SUMMARY

Generally, in one aspect, a cooking utensil (such as a stock pot, frying pan, sauce pan, or other type of cookware) for use with an induction cooktop is constructed such that it heats the food/liquid within its chamber to a desired cooking temperature while maintaining a relatively cool outer surface, and preferably an outer surface that is cool enough to pick up with a person's bare hands and immediately set on a wooden (or other) table without damaging it.

Generally, in another aspect, a cooking utensil for use with an induction cooktop includes an inner wall that is made at least in part of an electrically conductive material and an outer wall that is at least partially separate from the inner wall to define a gap. The outer wall includes a plurality of openings that permit circulation of air between the gap and the outside of the cooking utensil.

Implementations may include one or more of the following. The outer wall may be made at least in part of a non-conductive (e.g., insulating) material. The cooking utensil may also include a reflective layer disposed between the inner and outer walls. The openings may be disposed on the bottom and/or sidewalls of the outer wall. The outer wall may also include features to raise the bottom surface from the top of the cook top. The outer wall may be the outermost wall of the cooking utensil.

The inner wall may be formed of multiple layers (e.g., stainless steel, aluminum, etc.). The outside of the inner layer may include a coating of a non-stick material. The inner wall may be the innermost wall of the cooking utensil.

Generally, in another aspect, an induction cooking system includes an induction cooktop and a cooking utensil that includes an inner wall that is made at least in part of an electrically conductive material and an outer wall that is at least partially separated from the inner wall to define a gap. The outer wall of the cooking utensil includes a plurality of openings that permit circulation of air between the gap and outside of the cooking utensil. Implementations may include one or more of the features and/or characteristics recited above.

Generally, in another aspect, a method for manufacturing an induction cooking utensil includes providing an inner wall that includes at least some electrically conductive material, providing an outer wall that includes a plurality of openings, and attaching the inner wall and the outer wall such that there is a gap defined between the inner and outer walls to permit circulation of air between the gap and the outside of the cooking utensil.

Implementations include one or more of the following. The outer wall may be formed of an electrically non-conductive material (e.g., insulating material). The method may also include disposing a reflective layer between the inner and outer walls.

### DESCRIPTION OF DRAWINGS

FIGS. 1A and 2 are cross-sectional views of induction cookware.

FIG. 1B is a detailed cross-sectional view of a portion of the cooking utensil shown in FIG. 1A.

FIGS. 3A-3B are partial cross-sectional views of an inner wall of an induction cooking utensil.

FIG. 4A is a cross-sectional view an induction cooking utensil.

FIG. 4B is a bottom view of the cooking utensil shown in FIG. 4A.

FIGS. 5A and 5C are each a cross-sectional view of an induction cooking utensil.

FIGS. 5B and 5D are each a detailed cross-sectional view of a portion of the cooking utensil shown in FIGS. 5A and 5C respectively.

FIG. 6A is a perspective view of an induction cooking utensil.

FIG. 6B is a bottom view of the cooking utensil shown in FIG. 6A.

FIG. 6C is a cross sectional view of the cooking utensil shown in FIGS. 6A-6B.

### DETAILED DESCRIPTION

Cookware used with an induction cooktop may be designed to rapidly heat food or liquid while maintaining an outer surface that is cool enough to handle with bare hands or directly place on a wooden dining table (or other heat sensitive surface) without causing damage. To do this, the cookware should be constructed in a way so that any component between the induction coil and the target allows the magnetic field produced by the induction coil to reach the target (that is the component should be essentially invisible to the magnetic field) and also have a high thermal resistance (to abate radiant, convective, and conductive heat transfer from the target material to the outside of the cookware).

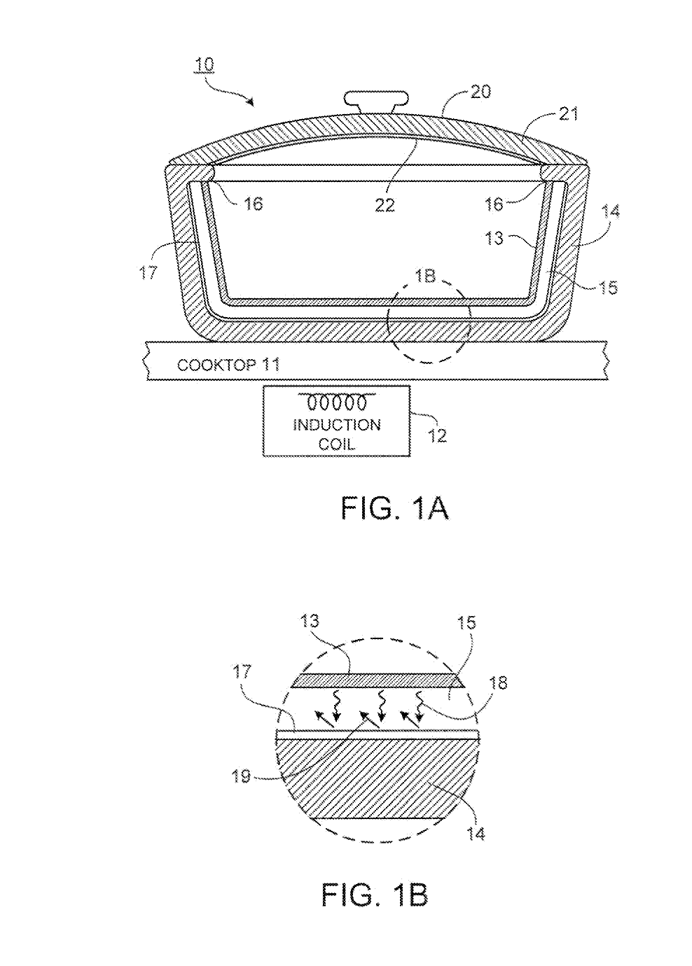

For example, as shown in FIG. 1A, a cooking utensil 10 sits on the surface 11 of an induction cooktop above the cooktop's induction coil 12. The cooking utensil 10 includes an inner wall 13 and outer wall 14 separated by a vacuum gap 15 and attached at a joint 16. A thin layer of radiant heat reflective material 17 is disposed between the inner and outer walls on the inner surface of the outer wall 14.

The inner wall 13 is the target of the induction coil 12 and is formed of an electrically conductive material, and preferably a ferromagnetic material such as 410 stainless steel. The material of the inner wall may be engineered to have a particular Curie point to help prevent the inner wall from exceeding a predetermined temperature (e.g., 250° C.-275° C.).

The outer wall 14 is designed to stay relatively cool even while the inner wall (and food or liquid within the cooking utensil) is heated to high temperatures for extended periods of time. For example, the induction cooktop may heat the target material to 233° C.-275° C. while the outer surface of the cooking utensil is maintained at about 60° C. or less. In this example, the outer wall 14 is formed at least in part, of an electrically non-conductive material (e.g., an insulator having a resistivity greater than about one ohm-meter), such as glass ceramic, glass, or plastic (e.g., a plastic such as polyether sulfone resin (PES), Liquid Crystal Polymer (LCP), or Polyetheretherketone (PEEK)). For implementations that include a vacuum gap between the inner and outer walls, the material of the outer wall is also preferably formed of material that is impermeable to atmospheric gasses, and either inherently does not outgas, or is provided with a barrier material which prevents outgassing (to preserve the vacuum). Applications which include a vacuum gap (pressures of between 0.001 and 1 torr) significantly reduce both conductive and convective heat transfer from the target surface to the outer surface.

The thin layer of reflective material 17 reflects a significant portion of the radiant heat radiated by the inner wall (i.e., the target of the induction coil) away from the outer surface, thus helping to keep the outer wall 14 relatively cool. This reflective layer may be formed of any material having a high reflectance (e.g., greater than 80% and preferably between 90-100%) and low emissivity (e.g., an emissivity less than about 0.20 and preferably around 0.01-0.04) for radiation in the infrared and visible electromagnetic spectra (e.g., radiation having a wavelength of between 0.4 μm and 1×10⁴ μm). As shown in FIG. 1B, heat 18 radiated from the inner wall 13 is reflected 19 by the reflective layer 17 away from the outer wall. This permits the cooking utensil to have a thinner cross-sectional profile than would otherwise be required to maintain the temperature differential between the inner and outer walls. (A cooking utensil without the reflective layer would require a larger insulation gap and/or thicker outer wall to maintain the same temperature differential). In such cases, the target is moved further away from the induction coil, thus increasing the energy usage of the coil and reducing the coupling efficiency between the coil and the target.

The reflective layer may lie between the induction coil and the target (as is shown in FIG. 1A), and, as such, the reflective layer should be designed to prevent it from attenuating a significant portion of the magnetic field. In other words, the reflective layer should be designed to be essentially invisible to the magnetic field created by the induction coil. For example, in some implementations the reflective layer may be formed of a dielectric material which is non-conductive and thus does not attenuate the magnetic field. However, in some implementations the reflective layer may be formed of a conductive material such as a metal (e.g., pure or alloy forms of gold, silver, aluminum, palladium, nickel, etc.). In this case, the conductive reflective layer is made thin enough to prevent it from attenuating a significant portion of the magnetic field produced by the induction coil. The thickness of a conductive reflective layer may be designed to be less than the skin depth of the material (at the frequency of operation of the induction coil). For example, in the cooking utensil example of FIGS. 1A-1B the reflective layer is formed of silver and has a thickness of on the order of about 1000×10⁻¹⁰ meters (the figures including FIGS. 1A-1B are not drawn to scale), which is about three orders of magnitude less than the skin depth of silver (approximately 3.7×10⁻⁴ meters at 30 kHz). Also, some percentage of the conductive reflective layer may be etched away to create interruptions in the current path. Breaking the current path that would otherwise be induced in the reflective layer by the field (e.g., etching a grid or other pattern in the reflective layer) may allow for design of a thicker conductive reflector (e.g., reflective layers that are roughly equal to or exceeding the skin depth of the material at the induction coil frequency of operation).

The reflective layer may be formed using any known technique for the particular material. For example, a dielectric reflective layer such as Spectraflect® by Labsphere in North Sutton, N.H. USA (www.labspere.com) may be coated onto the inner surface of the outer wall. Other dielectric reflectors may be produced in sheets and may be adhered to the outer wall. Other metallic reflectors may be coated on thin-film polymeric substrates such as Kapton® by E. I. du Pont de Nemours and Company, Wilmington, Del., USA, which in turn may be adhered to the outer wall. Additionally, evaporation coating may be used to deposit a thin layer of a metallic reflector on the inner surface of the outer wall.

It should be noted that the reflective layer need not be attached to the outer wall. In some implementations, the reflective layer may be disposed on the outer surface of the inner wall. In other implementations, the reflective layer may be a separate structure disposed between the inner and outer walls; for example, a layer of thermal insulating material (e.g., aerogel) may be disposed between the inside of the outer wall and the reflective layer.

Referring again to FIG. 1A, the cooking utensil 10 includes a lid 20 that is formed of a thermally insulating material 21 and includes a layer of reflective material 22 on its inner surface. This layer of reflective material reflects heat radiated from the inside of the cooking utensil away from the exterior surface of the lid, thus helping to keep the lid cool and the chamber of the cooking utensil warm.

The joint 16 between the inner and outer walls may be formed using any known joining technique (e.g., joining with a high-temperature adhesive, mechanical seal (such as an o-ring), or a brazed joint). For implementations that include a vacuum gap between the inner and outer walls (such as shown in FIGS. 1A-1B), the gap between the inner and outer walls may be evacuated during the joining process, or the joining process may take place in a vacuum chamber.

In an implementation that includes a vacuum gap, the pressure in the gap will increase over time regardless of the materials selected for the walls and the quality of the joint due to outgassing of the bulk materials and leakage at the joint. Metallic and glass/glass ceramic materials will outgas very slowly, while polymeric materials will outgas relatively rapidly. As the pressure increases, the thermal resistance of the cooking utensil diminishes. One technique for helping to slow the leakage of gas into a vacuum gap for a polymeric material is to seal the outer wall using a thin film coating such as an ultra low-outgassing epoxy or a metallic coating. In addition, however, a getter material may be disposed between the inner and outer walls to help preserve the vacuum over time (and thus also helping to maintain the cookware's thermal resistance over time).

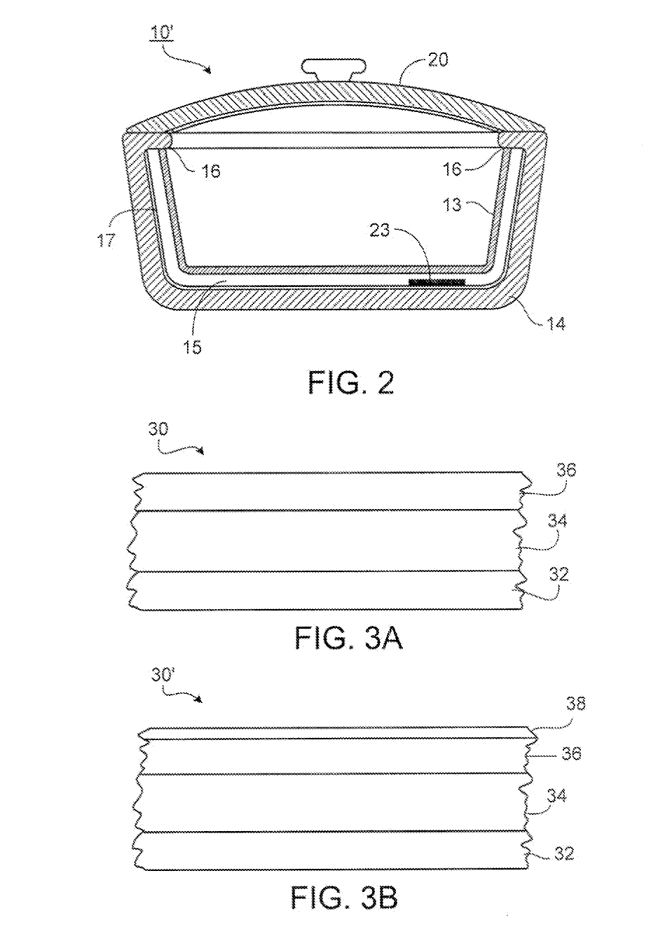

For example, as shown in FIG. 2, a cooking utensil 10′ is identical in construction to the example shown and described in FIG. 1 except that it includes an amount of a getter material 23 (e.g., a Zirconium-based alloy available from SAES Getters S.p.A. in Milan, Italy (www.saesgetters.com)) attached (e.g., by welding or adhering) to the inside of the outer wall in the gap. The getter material may be pre-activated and installed into the cookware in an active state, or alternatively, it may be installed in an inactive state and then activated by heating the cookware after assembly. When the getter material is in an active state, it will absorb gas (e.g., N₂, O₂, CO, and CO₂) that has leaked into the gap between the inner and outer walls and thus preserves the vacuum.

Getter material may also be used to reduce the pressure existing between the inner and outer chambers. For example, a larger amount of getter material may be placed between the inner and outer walls and then activated after the walls are joined to form the vacuum, however the getter will not absorb Argon gas, which is present in the atmosphere. Alternatively, the air in the gap between the inner and outer walls may be evacuated during the joining process to achieve a vacuum at a certain magnitude (e.g., 1 torr) and then getter material may be activated to increase the magnitude of the vacuum (e.g., to 1×10⁻³ torr).

While the cookware illustrated thus far show single layer inner and outer walls, other implementations may use multi-layered inner and/or outer walls. For example, as shown in FIG. 3A, an inner wall of an induction cook cooking utensil 30 includes a three-layer design that includes a lower layer 32, middle layer 34, and upper layer 36. The lower layer 32 is formed of a material designed to be a good target for the induction coil, such as 410 stainless steel having a thickness of roughly 0.76 mm. The middle layer 34 is formed of a material, such as 1060 aluminum, that effectively and evenly spreads heat generated in the target material. Finally, the upper layer 36 is formed of a material such as 305 stainless steel having a thickness of about 0.8 mm. FIG. 3B shows a similar multi-layered design, except in this example, a non-stick layer 38 (e.g., PEEK available from Victrex Company in Conshohocken, Pa. (www.victrex.com), or Teflon® available from E. I. du Pont de Nemours and Company in Wilmington, Del. (www.dupont.com)) is applied on the uppermost surface of the inner wall 30′ to help prevent food and liquid from sticking to the cooking utensil.

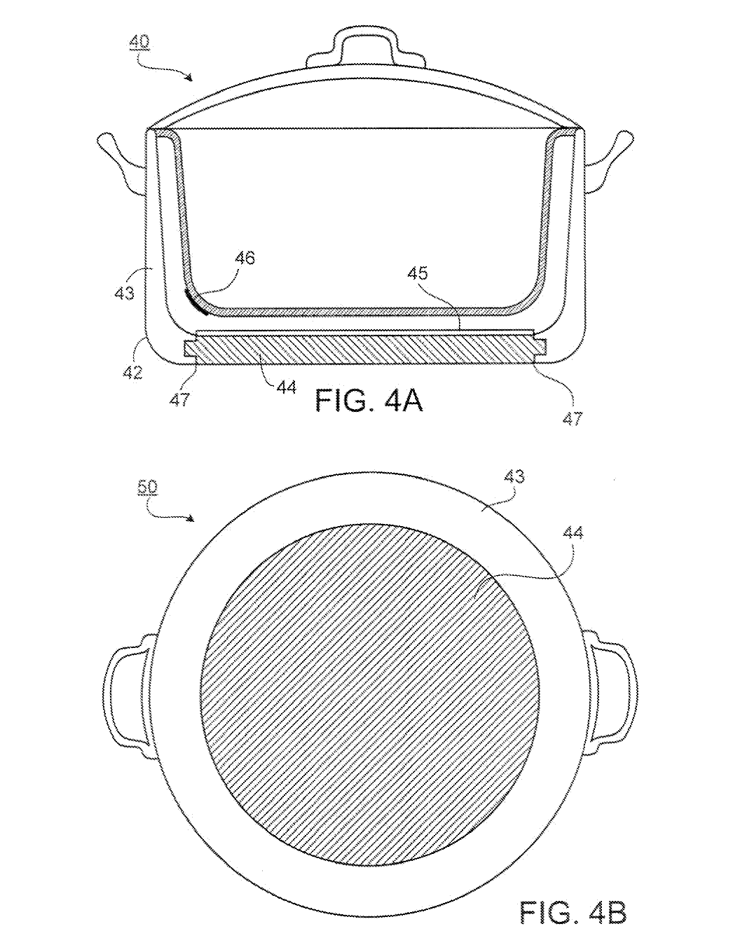

Referring now to FIGS. 4A-4B, an induction cooking utensil 40 is similar in construction to the cooking utensil 10 shown and described in FIGS. 1A-1B. However, in this example, the outer wall 42 includes a sidewall 43 formed of a metallic material and a window 44 formed of an electrically insulating material. Additionally, the reflective layer 45 is disposed only on the bottom of the cooking utensil, and not along its sidewalls as is shown in FIGS. 1A-1B. In this design, the cooking utensil 40 has the look of a conventional metallic cooking utensil, yet still has a high enough thermal resistance between the inside of the inner wall and the outside of the outer wall to maintain a relatively cool outer shell.

The insulating window 44 may be attached to the metallic sidewall 43 using any known technique for the materials selected, such as, brazing, insert molding, or attaching using an adhesive or a mechanical seal. The joint 47 between the insulating window 44 and metallic sidewalls 43 is preferably air-tight to preserve the vacuum. A piece of getter material 46 is also attached to the outside of the inner wall to preserve the vacuum over time. Any electrically non-conductive material may be used for the window, such as glass-ceramics (e.g., Robax® or Ceran® available from Schott North America, Inc in Elmsford, N.Y. (www.us.schott.com)), technical glasses (e.g., Pyrex® available from Corning Incorporated in Corning, N.Y. (www.corning.com), ceramic white ware (CorningWare® available from Corning Incorporated), or plastic (e.g., PES LCP, or PEEK). In some implementations, the insulating window may extend up into the sidewall portions of the outer wall, while a metallic sidewall may be attached to the outer surface of the insulating window on the side of the cooking utensil.

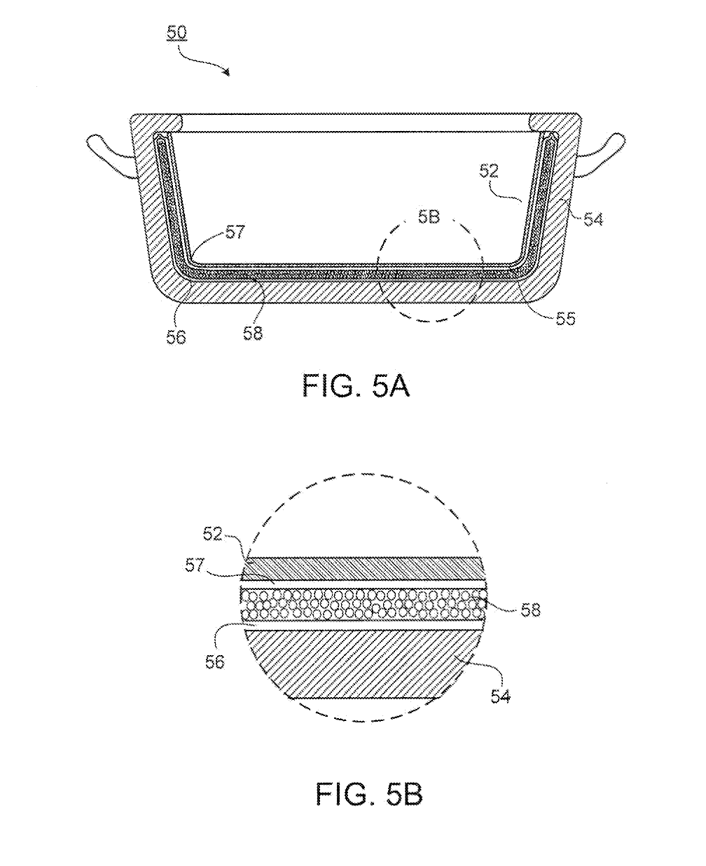

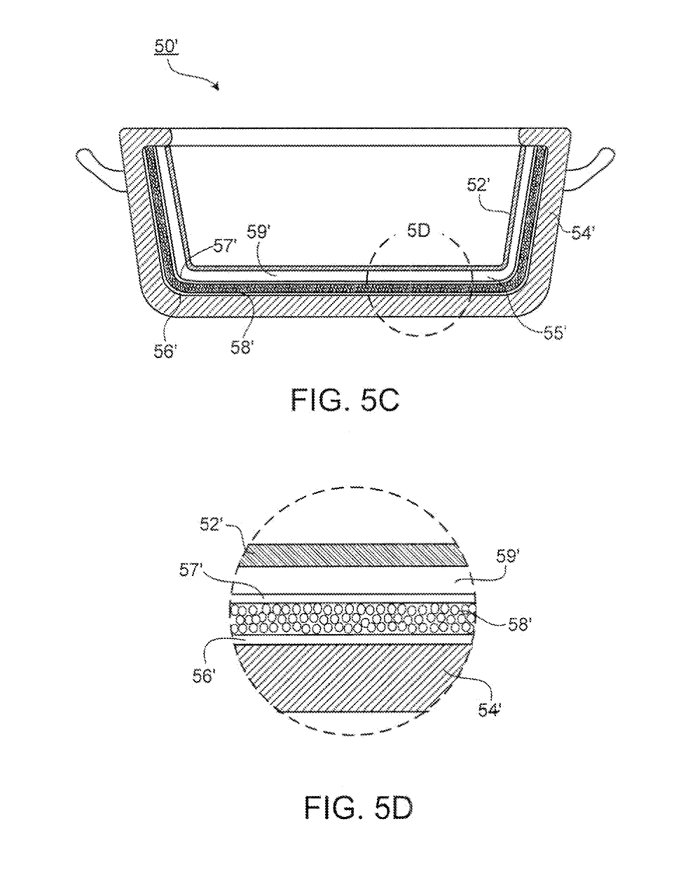

In some implementations, an induction cooking utensil may not have a vacuum gap that separates the inner and outer walls. For example, as shown in FIGS. 5A-5B, an induction cooking utensil 50 includes an inner wall 52 formed of an eclectically conductive material and an outer wall 54 formed of an electrically non-conductive material that is separated by a non-vacuum gap. A vacuum-sealed thermal insulator 53 is disposed within the gap and includes a thermally resistant material 58 that is vacuum-sealed between two sheets of material 56, 57. One or both of the sheets of material 56, 57 may be a reflective material to help reflect radiant heat away from the outer wall. For example, a layer of Nanopore™ thermal insulating material available from Nanopore, Inc. in Albuquerque, N.M. (www.nanopore.com) may be used between the inner and outer walls. In other implementations, non-reflective sheets of material 56, 57 may be used to vacuum-seal the thermally insulating material and one or more reflective layers may be disposed on the inside of the outer wall (such as what is shown in FIGS. 1A-1B), disposed as a separate layer in the gap, and/or disposed on the outside of the inner wall. Also, in some implementations a vacuum-sealed member may not line the entire gap separating the inner and outer walls as shown, but may line only a portion, such as the bottom portion of the utensil.

In another example shown in FIGS. 5C-5D, an induction cooking utensil 50′ is similar in construction as to the cooking utensil 50 shown in FIGS. 5A-5B. However, in this example, there is no vacuum existing between the inner and outer walls. More particularly, the induction cooking utensil 50′ includes an inner wall 52′ formed of an eclectically conductive material and an outer wall 54′ formed of an electrically non-conductive material that is separated by a non-vacuum gap. The gap includes a first reflective layer 56′ disposed on the inner surface of the outer wall 54′ and a layer of thermally resistant material 58′ (such as aerogel) disposed on top of the first reflective layer 56′. A second reflective layer 57′ is disposed on top of the layer of thermally resistant material 58′. In this implementation, an air gap 59′ exists between the inner and outer walls above the second reflective layer 57′. Note also that this implementation includes two reflective layers. The upper reflective layer 57′ reflects heat radiated from the inner wall 52′ away from the outer wall. The lower reflective layer 56′ reflects heat radiated from inner wall and the upper reflective layer 57′ away from the outer wall. The thermally resistant material 58′ is preferably of a type that is a good thermal insulator (such as a carbon aerogel or a silica aerogel with carbon). While two layers of reflectors are illustrated in FIGS. 5C-5D, other implementations may use additional layers of reflectors. Similarly, some implementations may use a single reflective layer that is from the inner or outer wall (or both) by a layer of thermally resistant material.

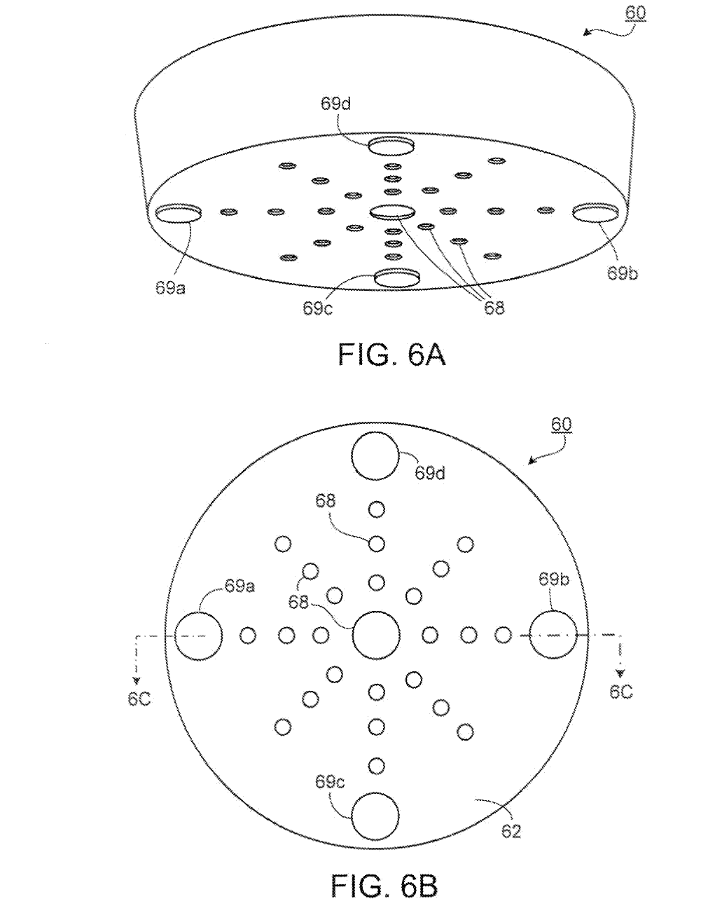

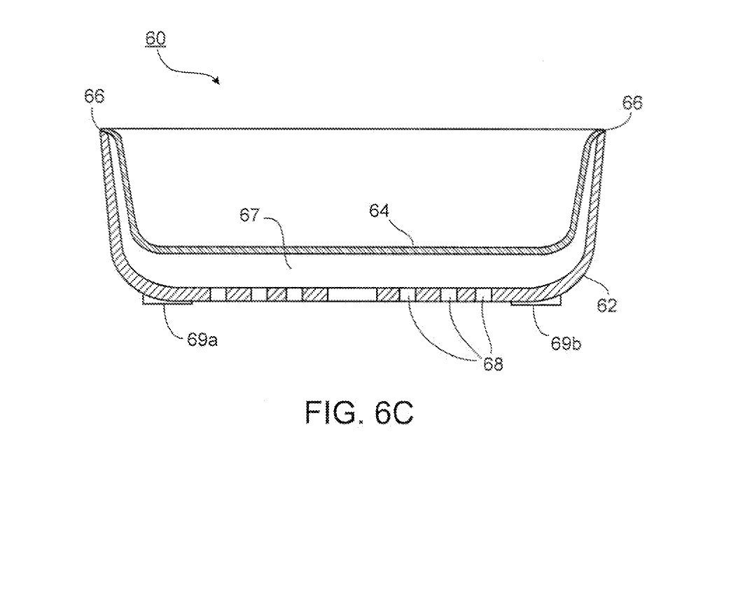

A cooking utensil may also include openings in its outer wall to promote convective cooling of the outer wall. For example, as shown in FIGS. 6A-6C an induction cooking utensil 60 includes an inner wall 64 formed of an electrically conductive material and an outer wall 62 formed of an electrically non-conductive material that is attached at a joint 66. In this case, the outer wall 62 includes a number of openings 68 on its bottom surface to promote airflow through the gap 67 separating the inner and outer walls. Cooking utensil 60 also includes features 69a-69d to slightly raise the bottom of the outer wall 62 from the surface of the cooktop, and thus more freely permit airflow through openings 68. The inner and outer walls may be attached at the joint 66 using any of the techniques described above. While this particular example shows openings only on the bottom surface of the outer wall, other implementations may include openings only on the sidewall or both on the side wall and bottom surface of the outer wall. Additionally, other implementations may include one or more reflective layers to further assist in keeping the outer wall relatively cool. It should also be noted that features similar to features 69a-69d shown in FIGS. 6A-6C may be used in any of the other implementations described herein to promote airflow between the bottom surface of the cooking utensil and the top surface of the cook top.

A number of embodiments of the invention have been described. Nevertheless, it will be understood that various modifications may be made without departing from the spirit and scope of the invention, and, accordingly, other embodiments are within the scope of the following claims.

We claim:

1. A cooking utensil for use with an induction cooktop having an induction heating coil, the cooking utensil comprising:
an inner wall comprising an electrically conductive material; and
an outer wall at least partially separated from the inner wall to define a gap, and wherein the outer wall include a plurality of openings that permit circulation of air between the gap and outside of the cooking utensil.

2. The cooking utensil of claim 1 wherein the outer wall is formed of an electrically non-conductive material.

3. The cooking utensil of claim 1 wherein the electrically non-conductive material of the outer wall comprises an insulating material.

4. The cooking utensil of claim 1 further comprising a reflective layer disposed at least partially between the inner and outer walls.

5. The cooking utensil of claim 1 wherein the openings are formed on the bottom of the outer wall.

6. The cooking utensil of claim 1 further comprising one or more features disposed on the outer wall to raise a bottom surface of the outer wall from a top surface of the cooktop.

7. The cooking utensil of claim 1 wherein the inner wall comprises a ferromagnetic material.

8. The cooking utensil of claim 1 wherein the inner wall comprises multiple layers of material, at least one of which is an electrically conductive material.

9. The cooking utensil of claim 8 wherein a first layer of the inner wall comprises a ferromagnetic material such as 410 stainless steel.

10. The cooking utensil of claim 9 wherein a second layer of the inner wall comprises aluminum.

11. The cooking utensil of claim 9 wherein a third layer of the inner wall comprises a non-ferromagnetic stainless steel such as 305 stainless steel.

12. The cooking utensil of claim 8 wherein another layer of the inner wall comprises a non-stick coating material.

13. The cooking utensil of claim 1 wherein the outer wall is the outermost wall of the cooking utensil.

14. The cooking utensil of claim 1 wherein the inner wall is the innermost wall of the cooking utensil.

15. An induction cooking system comprising:
an induction cooktop that includes an induction heating coil; and
a cooking utensil for use with the induction cooktop, the cooking utensil comprising:
an inner wall comprising an electrically conductive material; and
an outer wall at least partially separated from the inner wall to define a gap, and wherein the outer wall include a plurality of openings that permit circulation of air between the gap and outside of the cooking utensil.

16. The system of claim 15 wherein the outer wall of the cooking utensil is formed of an electrically non-conductive material.

17. The system of claim 15 wherein the cooking utensil further comprises a reflective layer disposed at least partially between the inner and outer walls.

18. The system of claim 15 wherein the openings are formed on the bottom of the outer wall.

19. The system of claim 15 wherein the cooking utensil further comprises one or more feet disposed on the outer wall to raise a bottom surface of the outer wall from a top surface of the cooktop.

20. A method for manufacturing an induction cooking utensil, the method comprising:
providing an inner wall that includes at least some electrically conductive material;
providing an outer wall that includes a plurality of openings; and
attaching the inner wall and outer wall such that there is defined a gap between the inner and outer walls and wherein the openings in the outer wall permit circulation of air between the gap and outside of the cooking utensil.

21. The method of claim 20 wherein the outer wall is formed of an electrically non-conductive material.

22. The method of claim 20 wherein the electrically non-conductive material of the outer wall comprises an insulating material.

23. The method of claim 20 further comprising disposing a reflective layer at least partially between the inner and outer walls.

24. The method of claim 20 wherein the openings are formed on the bottom of the outer wall.

25. The method of claim 20 further comprising forming one or more features on the outer wall to raise a bottom surface of the outer wall from a top surface of the cooktop.
